(19) United States
(12) Patent Application Publication
(10) Pub. No.: US 2014/0078863 A1
(43) Pub. Date: Mar. 20, 2014

(54) ASSAYING GOLD WITH A MICROWAVE PULSE

(71) Applicant: ELWHA LLC, Bellevue, WA (US)

(72) Inventors: Michael H. Baym, Cambridge, MA (US); Terry Briggs, Lone Tree, CO (US); Robert Dunne, Highlands Ranch, CO (US); W. Daniel Hillis, Encino, CA (US); Roderick A. Hyde, Redmond, WA (US); Muriel Y. Ishikawa, Livermore, CA (US); Jordin T. Kare, Seattle, WA (US); Conor L. Myhrvold, Bellevue, WA (US); Nathan P. Myhrvold, Bellevue, WA (US); Tony S. Pan, Cambridge, MA (US); Clarence T. Tegreene, Mercer Island, WA (US); Charles Whitmer, North Bend, WA (US); Lowell L. Wood, JR., Bellevue, WA (US); Victoria Y.H. Wood, Livermore, CA (US)

(73) Assignee: Elwha LLC, Bellevue, WA (US)

(21) Appl. No.: 13/621,731

(22) Filed: Sep. 17, 2012

(51) Int. Cl. G01V 1/30

(52) U.S. Cl. CPC G01V 1/306
USPC 367/49

(57) ABSTRACT

A system for assaying gold in a rock formation includes a transmitter and an acoustic sensor. The transmitter is configured to transmit a microwave pulse into the rock formation. The acoustic sensor is coupled to the rock formation and is configured to detect an acoustic wave emitted from the rock formation in response to receipt by the rock formation of the microwave pulse.

### BACKGROUND

In some gold mining operations the miners may not know whether gold exists in the content being mined or excavated without obtaining a sample and performing an assay, such as a fire assay, on the sample, generally at an off site location. The assay process may take multiple days and may still provide fairly limited amounts of information about the materials in the ground in the remainder of the site.

Current systems and methods for surveying a gold mine can cause undue delays in the mining operations and can be inefficient because a great deal of material may be excavated and energy may be expended only to discover gold is non-existent therein.

### SUMMARY

Time, money and energy may be saved and gold mining may be substantially more efficient and accurate through the use of efficient gold assay techniques. In view of the foregoing, the present disclosure is directed to systems and methods for assaying gold with microwave radiation.

In one exemplary embodiment, a system for assaying gold in a rock formation is provided. The system includes a transmitter configured to transmit a microwave pulse into the rock formation and an acoustic sensor coupled to the rock formation. The acoustic sensor is configured to detect an acoustic wave emitted from the rock formation in response to receipt by the rock formation of the microwave pulse.

In another exemplary embodiment, as system for assaying gold in a rock formation is provided. The system includes a transmitter configured to transmit a microwave pulse into the rock formation. The system also includes a scanner coupled to the transmitter. The scanner is configured to scan the transmitted microwave pulse over an area within which the rock formation is disposed. The system includes yet further, an acoustic sensor configured to be coupled to the rock formation. The acoustic sensor is configured to detect an acoustic wave emitted from the rock formation in response to receipt by the rock formation of the microwave pulse.

Other exemplary embodiments disclosed herein provide methods for assaying gold in a rock formation. The method includes causing transmission, via a transmitter, of a microwave pulse into the rock formation and detecting, via an acoustic sensor coupled to the rock formation, acoustic waves emitted from the rock formation in response to receipt by the rock formation of the microwave pulse.

Another exemplary embodiment provides a method of assaying gold in a rock formation. The method includes extracting rock from the rock formation. The method also includes causing transmission, via a transmitter, of a microwave pulse into the extracted rock. The method includes scanning the transmitted microwave pulse over an area within which the extracted rock is disposed and detecting, via an acoustic sensor coupled to the extracted rock, acoustic waves emitted from the extracted rock in response to receipt by the extracted rock of the microwave pulse.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE FIGURES

The skilled artisan will understand that the drawings primarily are for illustrative purposes and are not intended to limit the scope of the inventive subject matter described herein.

FIG. 1 provides a flow-chart illustrating a process for assaying gold, in accordance with one exemplary embodiment.

FIG. 2 provides a flow-chart illustrating a process for assaying gold in a rock formation in situ, in accordance with another exemplary embodiment.

FIG. 3 depicts a system for assaying gold in extracted rock formations, in accordance one exemplary embodiment.

FIG. 4 shows a top view of the system depicted in FIG. 3.

FIG. 5 illustrates a mobile assay system for assaying gold in extracted rock formation, in accordance with another exemplary embodiment.

FIG. 6 illustrates a system for assaying gold in extracted rock formation, in accordance with yet another exemplary embodiment.

FIG. 7 illustrates a system for assaying gold in extracted rock formation with a plurality of conveyance components, in accordance with one exemplary embodiment.

FIG. 8 provides a top view of the system illustrated in FIG. 7.

FIG. 9 depicts a mobile assay system for assaying gold on in situ rock formation, in accordance with one exemplary embodiment.

FIG. 10 depicts an assay system for assaying gold in a load of rocks removed from a rock formation in accordance with one exemplary embodiment.

The features and advantages of the inventive concepts disclosed herein will become more apparent from the detailed description set forth below when taken in conjunction with the drawings.

### DETAILED DESCRIPTION

Following below are more detailed descriptions of various concepts related to, and embodiments of, inventive apparatuses, methods, and systems for assaying gold. It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes.

Various exemplary embodiments are directed generally to apparatuses methods for assaying gold in a rock formation. The concepts disclosed herein may have substantial utility in the context of gold mining applications.

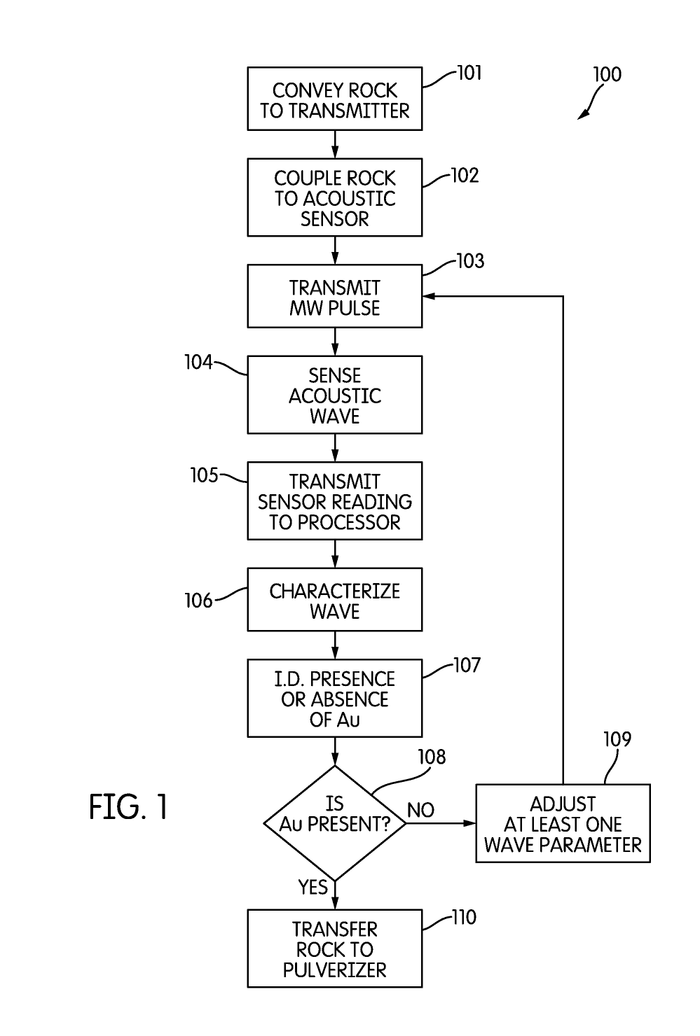

FIG. 1 provides a flow-chart illustrating a process for assaying gold, in accordance with one exemplary embodiment. The assaying process may be suitable for assaying content of rock formations extracted from a mining site, such as a gold mining site, as well as for assaying content of rock in-situ in the surrounding mining region. In some embodiments, the initial step to implementation of some apparatuses provided herein may require that a piece of rock first be extracted from a gold mine. As demonstrated by step 101, in accordance with some embodiments, the extracted rock may then be conveyed to a location wherein the assay will take place. More specifically, the extracted rock formation may be positioned such that the rock formation is disposed in the beampath of a transmitter, such as an electromagnetic antenna or antenna array configured to transmit one or more pulses of microwave radiation. The rock is then coupled with an acoustic sensor in step 102, in association with the anticipated microwave transmission. By way of example, the rock may be positioned in a fluid, liquid, or gel to improve acoustic coupling. Preferably, such coupling material has an acoustic impedance intermediate that of the rock formation and that of the acoustic sensor; however it may have an acoustic impedance substantially matching that of either the rock formation or the acoustic sensor. Preferably, such coupling material extends between the rock and the acoustic sensor, contacting both; however, in some embodiments, the coupling material may only contact one of the sensor or rock formation, or may not extend fully between the two of them. By way of example, the rock may be positioned in a fluid, liquid, or gel to improve microwave coupling. Preferably, such coupling material has a microwave refractive index intermediate that of the rock formation and that of the transmitter; however it may have a microwave refractive index substantially matching that of either the rock formation or the transmitter. Preferably, such coupling material extends between the rock and the transmitter, contacting both; however, in some embodiments, the coupling material may only contact one of the transmitter or rock formation, or may not extend fully between the two of them. In some embodiments, the coupling material can comprise both an acoustic coupling material and a microwave coupling material.

Once the extracted rock formation is positioned in the beampath of the microwave pulse transmitter, which position may be indicated by one or more position indicators (including, but not limited to radar, infrared, or laser sensors) or may be manually indicated by a monitoring operator, the transmitter will be actuated to transmit a microwave pulse at the rock formation as demonstrated by step 103. Immediately after the pulse is transmitted to the rock formation, a reading may be obtained from the acoustic sensor coupled to the rock in step 104. In some embodiments, the acoustic sensor may be continuously monitored before during and after the pulse is transmitted. In some embodiments, a reading may be obtained from the acoustic sensor based on the time of transmission of the microwave pulse. In some embodiments the acoustic sensor may be electronically coupled to the transmitter to facilitate knowledge of the activation of the transmitter to transmit the pulse. The sensor may also be coupled to the transmitter such that information such as duration, frequency, and separation of the microwave pulses are transmitted to the acoustic sensor or to a processor coupled to the acoustic sensor (e.g., in a feedback loop such that the pulse duration of the transmitter may be adjusted in response to an output from the acoustic sensor). The acoustic sensor may include an ultrasonic sensor.

Once the acoustic sensor has been read, the reading may be transmitted in step 105 to a processor for further analysis and characterization of the acoustic wave. The processor may be configured to control the transmitter and the acoustic sensor. The processor may further be configured to activate each of the transmitter and the acoustic sensor so that the signal is detected at the appropriate time. As depicted in step 106, the processor may characterize the acoustic wave detected (or indicate that a wave was not detected). The characterization may involve analysis of the intensity, frequency spectrum, or phase of the acoustic wave. Values of wave parameters measured at different spatial locations may be used to determine the spatial locations or distributions of gold particles within the rock formation. The timing of the acoustic wave arrival at different spatial locations, as well as relative to the microwave pulse can also be used determine the spatial locations or distributions of gold particles within the rock formation. The characterization of the pressure wave detected by the acoustic sensor may be used by the processor in step 107 to identify the presence or the absence of gold (Au) in the extracted rock formation, as well as information concerning the amount of gold and the sizes of gold particles. Upon entering the rock, the microwaves propagate through it with some scattering and refraction, but relatively little absorption. However, when microwaves reach a metallic particle, such as gold, they induce local currents, which result in resistive heating. The amount and physical extent of this heating depends on the electromagnetic penetration of the particle, which is based on the ratio of the skin depth to the particle size. Skin depth is inversely proportional to the square root of the particle's conductivity and the microwave frequency; for gold at a 10 GHz frequency, the skin depth is ˜0.8 microns. For particles smaller than the skin depth, the microwaves penetrate and heat the whole particle at a volumetric rate of ˜σE² volume (σ being the conductivity and E the microwave electric field). But for particles larger than the skin depth, the heating is concentrated within a skin depth deep layer on the outside of the particle, with current magnitudes high enough to exclude the field from the interior of the particle. In either event, highly conductive materials such as gold particles heat more than the surrounding rock. Over sufficiently long time periods, this heat is thermally conducted into the surrounding rock, so the gold and the rock heat to essentially the same temperature despite the fact that most of the heat is initially generated within the gold particles; this type of heating generates little acoustic signature. However, if the microwaves are delivered within a short duration time pulse, the heat deposited within a gold particle is effectively trapped there until it can diffuse out into the surrounding rock. While gold has a relatively high thermal diffusivity (˜1.30 cm²/sec), rocks have a lower diffusivity (typically ˜0.01 cm²/sec), such that thermal transport is limited by the heat's ability to escape through the rock bordering the particle. The thermal diffusion time varies approximately as Δ²/D, so a one micron gold particle takes about 1 microsecond to thermally equilibrate with its surrounding rock, while 10 micron particles require 100 microseconds. For microwave pulses shorter than the particle's thermal escape time, the heat remains trapped within the particle. If the heating is high enough, the particle can melt or even vaporize; at lower values the particle remains solid, but at a significantly higher temperature than the surrounding rock. All of these responses feature thermal expansion of the gold into the surrounding rock. The timescale of the pulse determines whether this is a smooth, acoustically fairly quiet procedure, or whether the expansion is abrupt, driving a shock wave into the rock, and generating an intense acoustic wave. The relevant timescale here is the acoustic transit time across the particle, ˜Δ/c; Δ being the particle size and c the sound speed. For a one micron gold particle, this acoustic time is ˜0.3 nanoseconds, rising to 3 nanoseconds for 10 micron particles. Accordingly, microwave heating of small gold particles within rock can lead to significant thermal disequilibrium and generate strong acoustic waves. The behavior falls into 3 general regimes, depending upon the time duration of the microwave pulse. Pulses which are longer than the thermal diffusion time (˜100 microseconds for a 10 micron particle) lead to little thermal imbalance and little acoustic signature. Pulses shorter than this, but which are still longer than the acoustic transit time (˜3 nanoseconds for 10 micron particles), do lead to elevated particle temperatures, but relatively little acoustic wave generation. However, as the pulse width becomes comparable to or shorter than the transit time, the particle does expand sharply into the surrounding rock, generating strong acoustic waves. These acoustic waves can be detected by acoustic sensors outside the rock, and used to detect and characterize the gold particles contained therein.

If the processor, determines in decision step 108 that the extracted rock formation contains gold, the rock may be transferred in step 110 to an auxiliary system such as a pulverizer for further extraction of the gold from the rock formation. If the processor obtains a reading that indicates that no gold has been detected, the processor may adjust a parameter of the pulsed wave in step 109 such as the pulse width, pulse frequency, or pulse separation, and take a subsequent reading beginning at step 103 under the new parameter to account for prospective differences in gold particles in the rock formation that may have caused them not to be detected. The microwave frequency can be changed between low and high frequencies, hence changing the skin depth from high to low values, and thereby, for a given sized particle, changing the heat deposition from one dominated by volumetric to surface heating; the former generally exceeding the latter. Similarly, the microwave pulse width can be changed between low and high values, and thereby, for a given sized particle, changing from strong to weak acoustic wave generation, and also changing the frequency spectrum of the generated ultrasound from higher to lower values. Additionally, the processor may be configured to identify the location of a gold particle detected in the rock formation based on the characterization of the acoustic wave. The processor may also be configured to identify the size of a gold particle detected in the rock formation. In some embodiments, the processor may cause the extracted rock formation to be discarded in view of the negative reading.

While the processes shown in FIG. 1 are representative of an exemplary embodiment, other inventive embodiments for assaying gold (in both in situ and in extracted rock formations) may include only some of the stages shown in the flow-chart provided in FIG. 1.

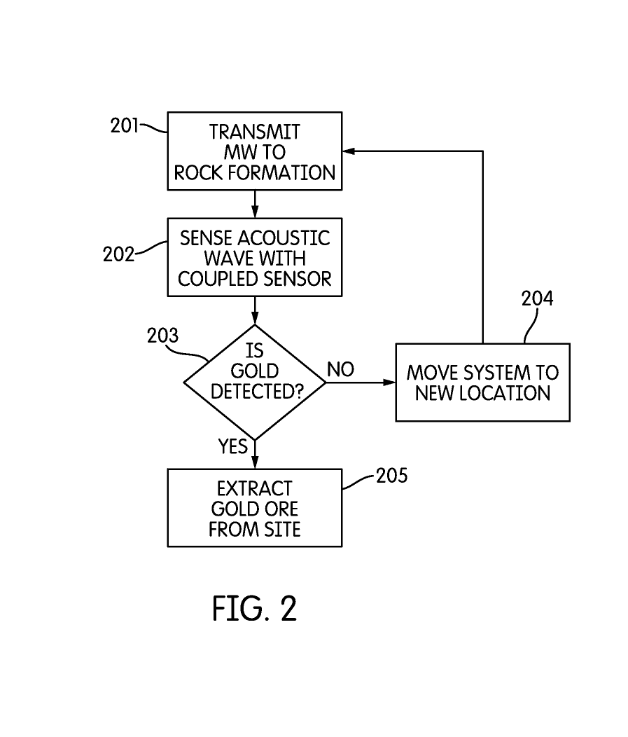

FIG. 2 provides a flow-chart illustrating a process for assaying gold in a rock formation in situ, in accordance with another exemplary embodiment. In accordance with some embodiments, a system may be provided that permits analysis of a rock formation before the rock formation is removed from the surrounding earth. In such a system, the initial step may simply include transmitting a microwave pulse to a rock formation in-situ as demonstrated in step 201. The rock formation may have an acoustic sensor coupled adjacent to the entry spot of the microwave. The acoustic sensor coupled thereto, may be read, as shown in step 202, during or immediately after the microwave pulse is transmitted into the rock. The microwave pulse can cause a gold particle within the rock to move, driving vibrations into the surrounding rock matrix. The acoustic sensor detects the vibration or pressure wave created by the gold particle vibrating in response to the microwave pulse. If such a wave is created it will generally propagate through the rock and into the coupling fluid contacting the rock surface and coupled to the acoustic sensor. A negative reading may be indicative of no gold particles within the rock. In some embodiments, a plurality of readings under varying conditions to account, for example for variation in particle size, may increase the accuracy of the reading. The information obtained from the acoustic sensor may in step 203 be analyzed to determine whether or not gold is present within the tested rock region. The analysis may include the use of an ultrasonic imager. If gold is identified based on a characterization of the reading from the acoustic sensor, gold ore may be extracted from the size in step 205. If gold is not detected, the system may be focused to at a new location in step 204 and the process repeated.

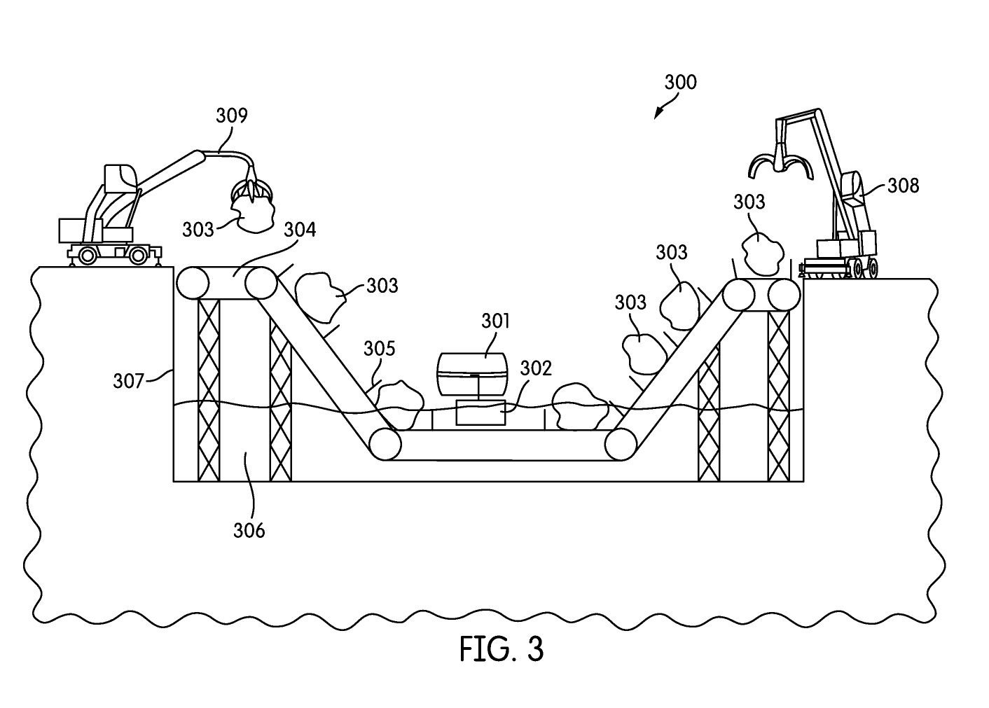

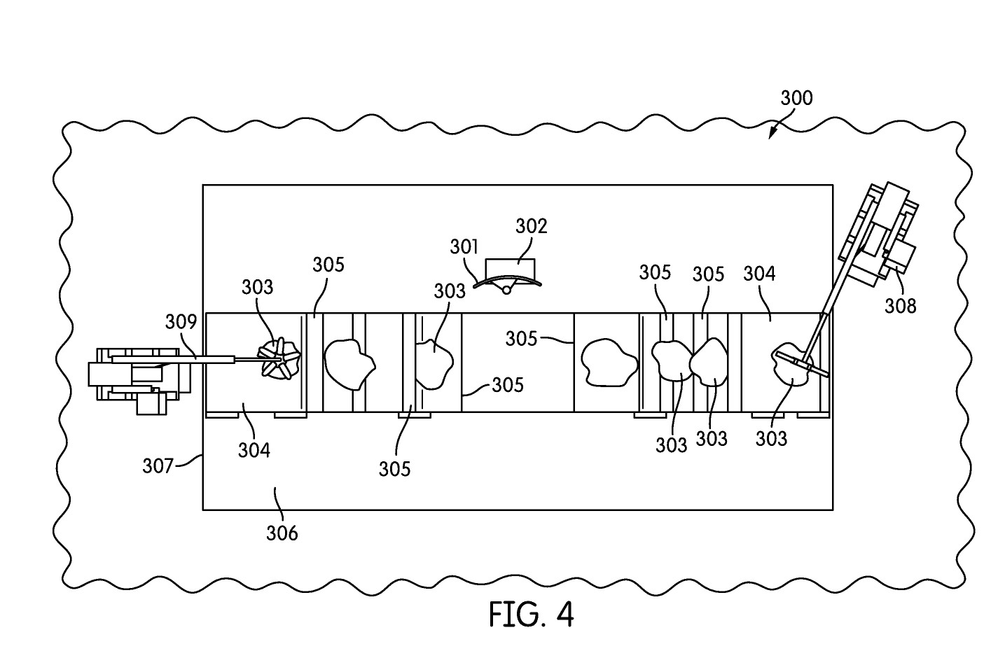

FIG. 3 depicts a system for assaying gold in extracted rock formations in accordance with one exemplary embodiment. FIG. 4 shows a top view of the system depicted in FIG. 3. The system depicted in FIG. 3 and FIG. 4 is one that may be set up adjacent to a mining site to complete on site gold assays before expending time and energy to pulverize every piece of rock extracted from a mining location. The system includes a first crane 308 or other system capable of moving extracted rocks 303 from a first removal site to a conveyor system 304. Conveyor system 304 may include one or more conveyor components. In the illustrated embodiment, conveyor system 304 is configured to move rocks placed on conveyor 304 via one or more stabilizing components 305. Conveyor system 304 may move extracted rocks 303 from a dry location to a location such as tank 307 immersed in coupling fluid 306 (e.g. water, gel, etc.) Tank 307 may include one or more acoustic transducers 302 positioned to contact coupling fluid 306 when the fluid is in contact with a rock 303 ready for assaying. The conveyor continues to move the rock 303 through the coupling fluid such that rock 303 is brought into alignment with an electromagnetic antenna 301 for transmitting microwave pulses into the extracted rock formation 303. Transmitter 301 may be configured to pulse the microwaves at a plurality of frequencies including frequencies in the GHz range. The microwave transmitter 301 may be positioned to transmit microwave pulses in a downward direction from above the conveyed rocks 303 in accordance with some embodiments. Transmitter 301 may be coupled to a source, such as a vacuum tube source configured to generate microwaves for transmission by the transmitter. In other embodiments, the microwave transmitter 301 may be posited to transmit microwave pulses laterally from a side of rocks 303. Transmitter 301 may be configured to transmit microwave pulses to the rock without first traveling through the coupling fluid in accordance with various embodiments. For example, the conveyor and fluid level 306 may be adjusted such that a surface of rock 303 is maintained outside of the coupling fluid 306. Transmitter 301 may be directed towards the dry or uncoupled surface either from the side or from above in accordance with various embodiments. In some embodiments, transmitter 301 may include a phased array, a coherent array, or an incoherent array of antenna. In some embodiments the transmitter may be stationary. In some embodiments, the transmitter may be stationary, but may be configured to transmit a steerable microwave pulse. In some embodiments, the transmitter may include an actuator for moving the position and direction of the transmitter.

Once the microwave pulse is transmitted, sensor 302 may be read to detect any pressure waves induced in rock formation 303 by gold particles disposed within rock formation 303. In some embodiments, the conveyor may be temporarily stalled such that rock remains in the line of sight of transmitter 303 for a plurality of readings. The plurality of readings may be automatic or may be initiated by a characterization of the reading from acoustic sensor 302 indicative of no gold within rock 303. In accordance with various embodiments, acoustic sensor 302 may include an ultrasonic detector. Once the appropriate microwave pulse transmission and acoustic detection has been completed rock 303 may continue to moved by conveyor 304 out of tank 307 and hence out of coupling fluid or gel 306. Based on the reading from sensor 302 the extracted rock formation may be separated into those with a positive gold reading and those with a negative gold reading. In accordance with some embodiments, a separate crane 309, which may be manually operated or may be autonomous, may be implemented to assist with the separation process. For example, crane 309 may remove rocks 303 with a negative reading from the system while allowing rocks 303 with a positive reading to pass through to a collection region for further processing. Alternatively, the crane could remove rocks 303 with a positive reading for further processing while allowing those with a negative reading to pass through to a collection region for discarding or returning to the mine.

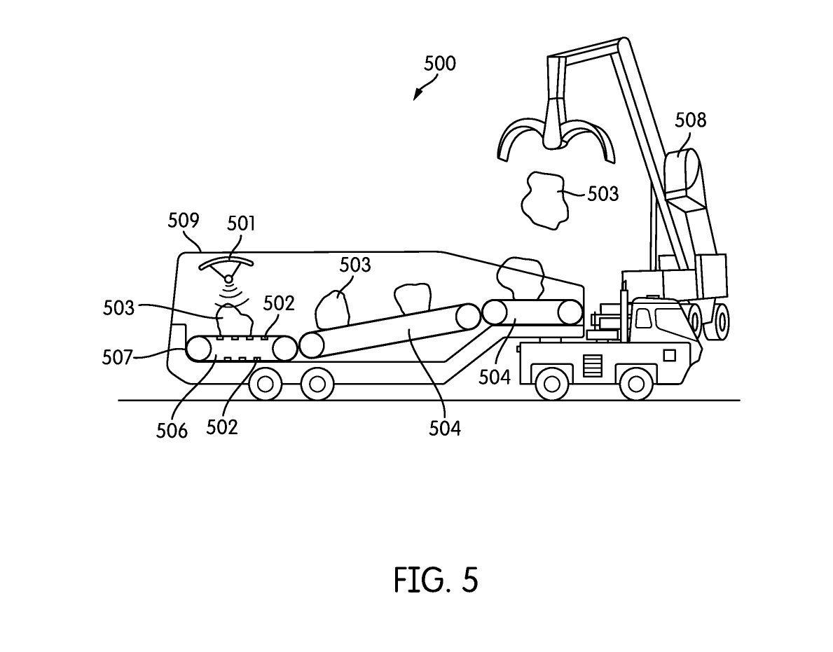

FIG. 5 illustrates a mobile assay system for assaying gold in extracted rock formation in accordance with another exemplary embodiment. As demonstrated in FIG. 5, the assay system may be embodied in a transport truck or van 509 and rocks 503 may be processed with the mobile transport vehicle or vehicle trailer on site at the mining location. The vehicle embodiment provides flexibility in terms of assay location on site and use of the system at various sites. A first transport component such as crane 508 may be used to deliver rocks 503 to mobile assay vehicle 509. Vehicle 509 may include an opening in the top or side to allow passage of the rock formations 503. Once the rock is inside assay vehicle 509, one or more conveyance systems 504 may be implemented to move rocks through the assay process. At least one of the conveyance systems may be configured to place rock formation 503 in contact with a coupling fluid 506 (e.g. water or gel). The conveyance system may also include one or more acoustic sensors 502 coupled to coupling fluid 506 such that upon activation of transmitter 501 to transmit a microwave pulse into the rock formation, a reading may subsequently be obtained by an acoustic sensor coupled to the rock formation during receipt of the microwave pulse.

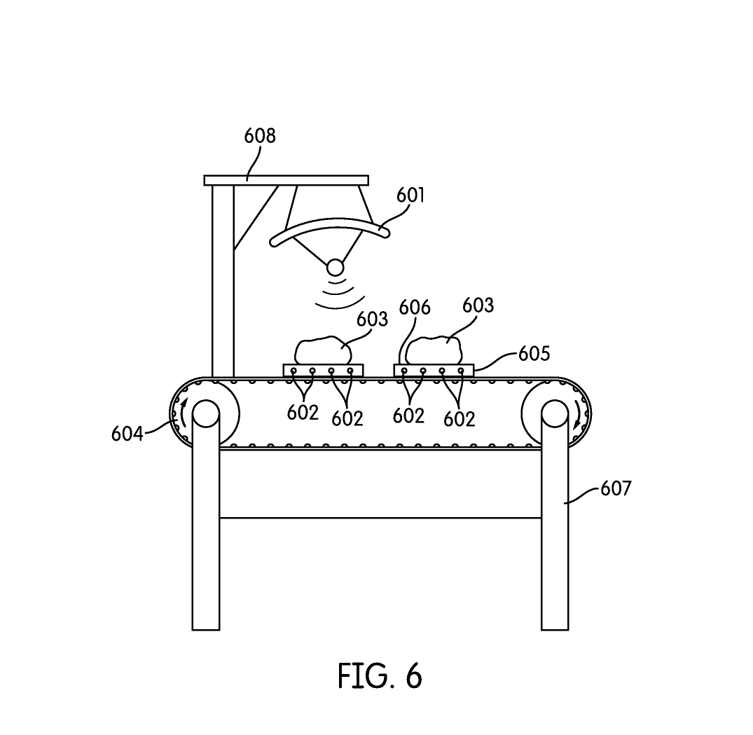

FIG. 6 illustrates a system for assaying gold in extracted rock formation in accordance with yet another exemplary embodiment. As depicted in FIG. 6, the assay system may include a stationary system with a linear conveyance system 604 in accordance with various embodiments. The conveyance system may be set up on a stand or table 607 for use in a wide variety of locations including inside of an onsite storage facility or shelter. The system may be operated by one or more operators and includes a plurality of conveyance trays 605 having a coupling fluid 606 disposed therein. The conveyance trays have one or more acoustic sensors 602 positioned therein, which sensors may be in direct contact with coupling fluid 606. Acoustic sensors 602 may be hardwired into the conveyance system or they may be configured for wireless transmission to a central processing device. Acoustic sensors 602 may be read once the extracted rock formation 603 is positioned in the line of sight of microwave pulse transmitter 601. The transmitter may be positioned on a support 608 to transmit from above. Support 601 may be configured to translate and rotate microwave pulse transmitter 608 along and about a plurality of axes.

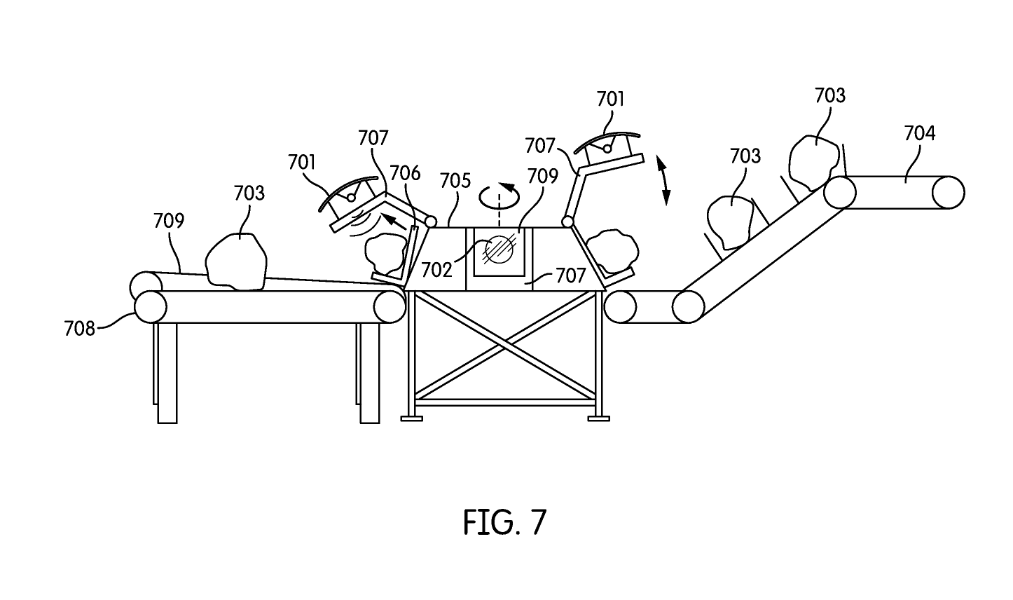

FIG. 7 illustrates a system for assaying gold in an extracted rock formation with a plurality of conveyance components in accordance with one exemplary embodiment. System 700 illustrated in FIG. 7 includes a plurality of distinct conveyance components in accordance with various embodiments. For example, system 700 includes two translating conveyor systems 704 and 708 and also includes a rotating carousel type conveyor 705. The upstream linear conveyor 704 translates rocks from an upstream source to the rotating carousel. When the rocks arrive at the carousel they are transferred by upstream conveyor 704 onto carousel 705. Once on the rotating carousel 705, a clamping system 707 may be implemented to hold the rock in place and facilitate the assay process. A microwave pulse transmitter 701 may be coupled to the clamping system in accordance with some embodiments. An acoustic sensor 702 and the associated coupling fluid or coupling medium 709 is positioned within the base or each carousel compartment. In a related embodiment, the transmitter may be positioned on the carousel body and the coupling fluid and acoustic sensor may be positioned on clamping component 707. The assay may be completed while the carousel rotates, such that microwave transmitter 701, when brought into line of sight with rock formation 703, may begin transmission of microwave pulses into the rock and acoustic sensors 702 may be monitored in response to transmission of the microwave pulses. After rotation to one or more other conveyors 708 and 709, clamp 707 is opened and compartment 706 is rotated radially outward to remove or eject assayed rock 703 onto one of conveyors 708 and 709. The compartment may be configured to eject a rock 703 with a positive reading for gold onto a first conveyor 708 and may be configured to eject a rock 703 having a negative reading for gold onto a second conveyor 709.

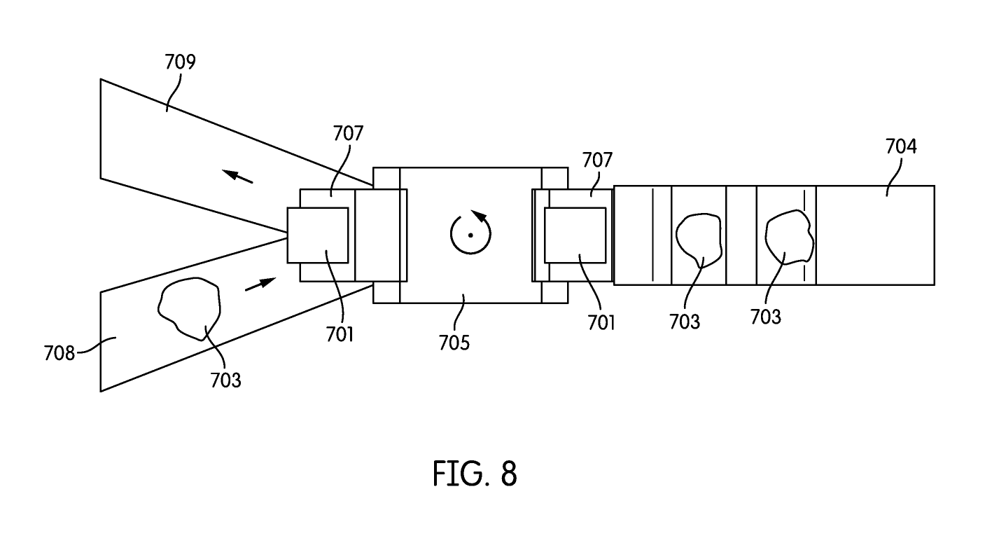

FIG. 8 provides a top view of the system illustrated in FIG. 7. Separate conveyor paths 708 and 709 are more clearly shown in FIG. 8. One path, for example conveyor 708, may lead to a storage bin or location for rocks with positive gold readings and the other path, for example conveyor 709, may lead to a storage bin or location for rocks with negative gold readings.

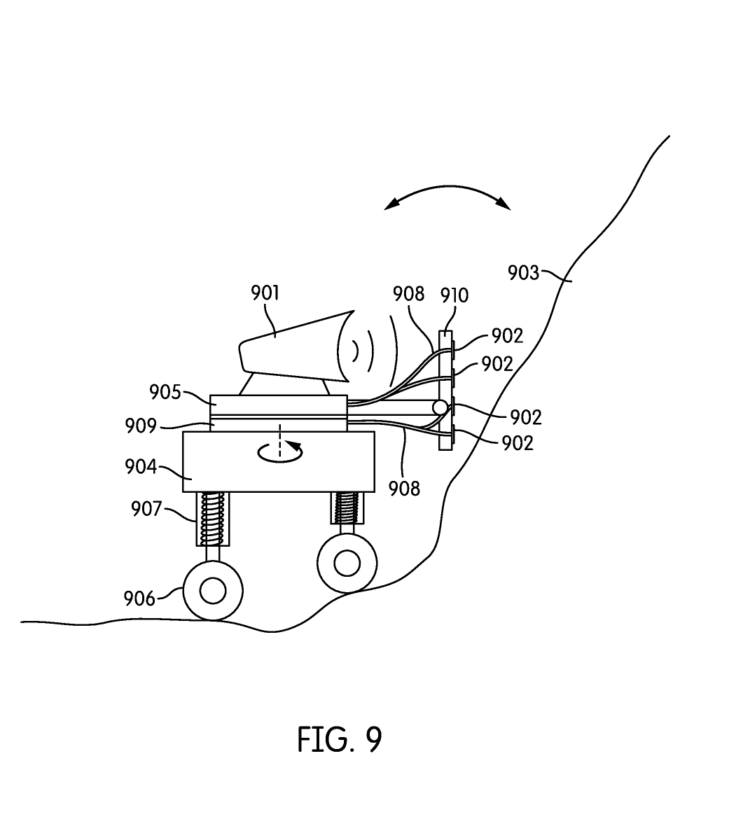

FIG. 9 depicts a mobile assay system for assaying gold on a rock formation in accordance with one exemplary embodiment. In the embodiment depicted in FIG. 9, the primary components, microwave pulse transmitter 901 and acoustic sensors 902 are structurally and mechanically coupled. In some embodiments, the transmitter and acoustic sensor may not be mechanically coupled, but may be in one way (e.g. transmitter to acoustic sensor) electrical communication with one another, may be in two way communication with one another, or may simply be coupled by one or more processors to which the transmitter and/or sensor may be electrically connected. In the illustrated embodiment, microwave pulse transmitter 901 and acoustic sensor 902 are disposed on mobile cart or vehicle 904. In some embodiments the microwave transmitter and acoustic sensor may be disposed in housing such as a handheld housing. A mobile cart or vehicle 904 includes wheels 906 and a compliant suspension system 907 to facilitate travel over uneven terrain. Acoustic sensors 902 are disposed on a compliant and extendable arm 905, which is rotatably coupled to vehicle 904. Sensors 902 may be disposed on a place 910 which also may be rotatable with respect to arm 909. Acoustic sensors 902 may include one or more hoses 908 provided a coupling fluid to the face of the sensors for coupling the sensors to the face of in-situ rock formation 903. Microwave pulse transmitter 901 is coupled to the rotatable extendable arm for positioning transmitter 901 for line of sight transmission to rock face 903. In another embodiment, not shown, the mobile assay system may be configured within a borehole compatible housing for deployment within a borehole, e.g., for real-time assaying during exploratory drilling.

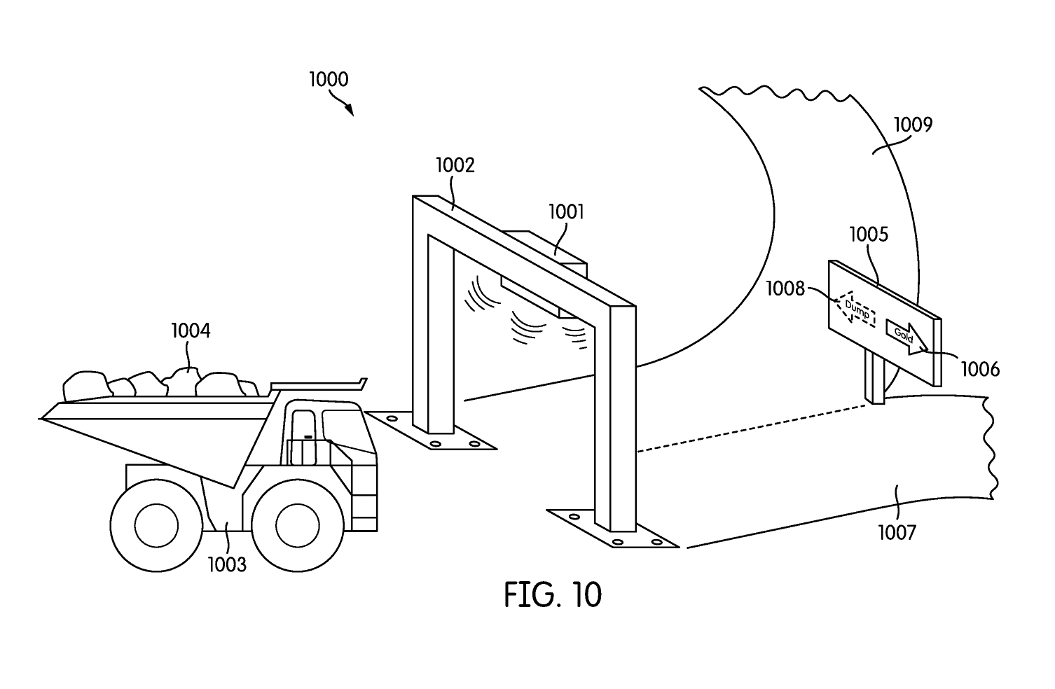

FIG. 10 depicts an assay system for assaying gold in a load of rocks removed from a rock formation in accordance with one exemplary embodiment. In one embodiment, the system includes a scanner configured to scan a load of rocks disposed in a vehicle, such as a dump truck 1003. The system may include a scanner 1000. Scanner 1000 may include a frame 1002 configured to position the microwave transmitter 1001 in a direct line of sight of the target rock material 1004. In some embodiments, scanner 1000 may include a fixed transmitter while the scanner may include a dynamic transmitter in other embodiments. Scanner 1000 includes detection sensors for receiving a signal propagating from material 1004 in response to receipt of the microwaves from transmitter 1001. The detection sensors, which may be disposed in the same housing as transmitter 1001 are configured to transmit a detected signal to a processor for analysis of the signal. The processor analyzes the signal to indicate whether or not gold particles are present in the rock material 1004. In response to this analysis a signal is transmitted to indicator 1005. The indicator provides instructions to the driver on where to take the rock material. For example, if the analysis indicates that gold is present, or that there is an amount of gold above a desired threshold, then the indicator will provide the driver with a signal 1006 to take material 1004 down path 1007 for further processing and/or pulverization. If the analysis indicates that gold is not present, a signal 1008 may be provided to the driver, to travel down path 1009 for disposal of the rocks. Each of paths 1007 and 1009 may lead to storage bins or to processing facilities for gold extraction and disposal respectively. In some embodiments, scanner 1001 may include a system providing a coupling fluid to be positioned between rocks 1004 and detecting sensors configured to detect a signal propagating from material 1004 in response to receipt of the microwaves from transmitter 1001. The system providing the coupling fluid may include a fluid conduit configured to expel fluid onto rock material 1004, while maintained in truck 1003. The system may also include activation sensors configured to automatically activate transmitter 1001 upon or shortly after the arrival of a truck within the vicinity of scanner 1000.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments of the invention can be implemented in any of numerous ways. For example, some embodiments may be implemented using hardware, software or a combination thereof. When any aspect of an embodiment is implemented at least in part in software, the software code can be executed on any suitable processor or collection of processors, whether provided in a single computer or distributed among multiple computers.

In this respect, various aspects of the invention may be embodied at least in part as a computer readable storage medium (or multiple computer readable storage media) (e.g., a computer memory, one or more floppy discs, compact discs, optical discs, magnetic tapes, flash memories, circuit configurations in Field Programmable Gate Arrays or other semiconductor devices, or other tangible computer storage medium or non-transitory medium) encoded with one or more programs that, when executed on one or more computers or other processors, perform methods that implement the various embodiments of the technology discussed above. The computer readable medium or media can be transportable, such that the program or programs stored thereon can be loaded onto one or more different computers or other processors to implement various aspects of the present technology as discussed above.

The terms “program” or “software” are used herein in a generic sense to refer to any type of computer code or set of computer-executable instructions that can be employed to program a computer or other processor to implement various aspects of the present technology as discussed above. Additionally, it should be appreciated that according to one aspect of this embodiment, one or more computer programs that when executed perform methods of the present technology need not reside on a single computer or processor, but may be distributed in a modular fashion amongst a number of different computers or processors to implement various aspects of the present technology.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, the technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

1. A system for assaying gold in a rock formation, the system comprising:
a transmitter configured to transmit a microwave pulse into the rock formation; and
an acoustic sensor configured to be coupled to the rock formation, the acoustic sensor configured to detect an acoustic wave emitted from the rock formation in response to receipt by the rock formation of the microwave pulse.

2. (canceled)

3. (canceled)

4. The system of claim 1, further comprising a processor coupled to the acoustic sensor, the processor configured to characterize the acoustic wave.

5. The system of claim 4, wherein the processor is configured to determine a source location of the acoustic wave.

6. The system of claim 5, wherein the source location is at least partially determined by a time of flight of the acoustic wave.

7. The system of claim 4, wherein the processor is configured to determine a size of one or more gold particles inside the rock formation at least partially based upon a frequency of the acoustic wave.

8. The system of claim 4, wherein the processor is configured to determine a size of one or more gold particles inside the rock formation at least partially based upon a pulse length of the acoustic wave.

9. The system of claim 4, wherein the processor is configured to determine an amount of gold particles inside the rock formation based upon the characterization of the acoustic wave.

10. The system of claim 4, wherein the processor is further configured to identify a particle size of a gold particle detected in the rock formation based on the characterization of the acoustic wave.

11. The system of claim 4, wherein the processor is configured identify a particle location of a gold particle detected in the rock formation based on the characterization of the acoustic wave.

12. The system of claim 1, further comprising a processor coupled to the transmitter to control transmission of the transmitter.

13. The system of claim 12, wherein the processor is configured to select a microwave frequency based upon a comparison of the microwave skin depth in a gold particle to an anticipated dimension of the gold particle.

14. The system of claim 12, wherein the processor is configured to select the duration of the microwave pulse based upon the transit time of an acoustic wave within a gold particle of an anticipated dimension.

15-21. (canceled)

22. The system of claim 1, wherein the rock formation is coupled to at least one of the acoustic sensor and the transmitter via a coupling material.

23. The system of claim 22, wherein the coupling material comprises an acoustic coupling material.

24. The system of claim 23, wherein the acoustic coupling material is configured to enhance acoustic coupling between the rock formation and the acoustic sensor.

25-26. (canceled)

27. The system of claim 22, wherein the coupling material comprises a microwave coupling material.

28. The system of claim 27, wherein the microwave coupling material is configured to enhance microwave coupling between the rock formation and the transmitter.

29. (canceled)

30. (canceled)

31. The system of claim 22, wherein the coupling material comprises both an acoustic coupling material and a microwave coupling material.

32-34. (canceled)

35. The system of claim 1, wherein the rock formation includes an extracted rock formation.

36. The system of claim 35, further comprising a conveyor.

37. The system of claim 36, wherein the conveyor is configured to position the extracted rock formation in a beampath of the transmitter.

38. The system of claim 36, wherein the acoustic sensor is positioned in the conveyor.

39. The system of claim 36, wherein a plurality of acoustic sensors are positioned in a section of the conveyor.

40. The system of claim 36, wherein the conveyor includes a container.

41. The system of claim 40, wherein the container includes a liquid for coupling the acoustic sensor to an extracted rock formation positioned in the container.

42. The system of claim 40, wherein the container includes a gel for coupling the acoustic sensor to an extracted rock formation positioned in the container, wherein the conveyor includes a translating conveyor.

43. The system of claim 36, wherein the conveyor includes a carousel.

44. The system of claim 36, wherein the conveyor includes a carousel and a translating conveyor.

45. The system of claim 36, wherein the conveyor is configured to move the extracted rock formation from a dry location to a wet location, the wet location including a liquid for coupling the acoustic sensor to the extracted rock formation.

46. The system of claim 36, further comprising a clamp for holding the extracted rock formation.

47. The system of claim 36, further comprising a separator for removing the extracted rock formation from the conveyor.

48. The system of claim 47, wherein the separator is configured to lift the extracted rock from the conveyor based on an output from the acoustic sensor.

49. The system of claim 47, wherein the separator is configured to push the extracted rock from the conveyor based on an output from the acoustic sensor.

50. The system of claim 36, wherein the conveyor is configured to convey the extracted rock formation to one of at least two identified locations based on an output from the acoustic sensor.

51-74. (canceled)

75. A system for assaying gold in a rock formation, the system comprising:
a transmitter configured to transmit a microwave pulse into the rock formation;
a scanner coupled to the transmitter, the scanner configured to scan the transmitted microwave pulse over an area within which the rock formation is disposed; and
an acoustic sensor configured to be coupled to the rock formation, the acoustic sensor configured to detect an acoustic wave emitted from the rock formation in response to receipt by the rock formation of the microwave pulse.

76. The system of claim 75, further comprising an extractor coupled to the acoustic sensor, the extractor configured to remove a portion of the rock formation in response to an acoustic wave detected by the acoustic sensor identifying the presence of gold.

77. A method of assaying gold in a rock formation, the method comprising
causing transmission, via a transmitter, of a microwave pulse into the rock formation; and
detecting, via an acoustic sensor coupled to the rock formation, acoustic waves emitted from the rock formation in response to receipt by the rock formation of the microwave pulse.

78. The method of claim 77, further comprising electrically transmitting a signal to the acoustic sensor in response to transmission of the microwave pulse.

79. (canceled)

80. The method of claim 77, further comprising characterizing the acoustic wave via a processor coupled to the acoustic sensor.

81. The method of claim 80, further comprising identifying a presence or an absence of gold in the rock formation based on the characterization of the acoustic wave.

82. The method of claim 80, further comprising determining a source location of the acoustic wave.

83. The method of claim 82, wherein the source location is at least partially determined by a time of flight of the acoustic wave.

84. The method of claim 80, further comprising determining a size of one or more gold particles inside the rock formation at least partially based upon a frequency of the acoustic wave.

85. The method of claim 80, further comprising determining a size of one or more gold particles inside the rock formation at least partially based upon a pulse length of the acoustic wave.

86. The method of claim 80, further comprising determining an amount of gold particles inside the rock formation based upon the characterization of the acoustic wave.

87. The method of claim 80, further comprising identifying a particle size of a gold particle detected in the rock formation based on the characterization of the acoustic wave.

88. The method of claim 80, further comprising identifying a particle location of a gold particle detected in the rock formation based on the characterization of the acoustic wave.

89-155. (canceled)
